(19) United States
(12) Patent Application Publication
(10) Pub. No.: US 2019/0297089 A1
(43) Pub. Date: Sep. 26, 2019

(54) On Premises Peer to Peer Credential Validation System and Method of Operation

(71) Applicant: Steven Mark Bryant, Bethesda, MD (US)

(72) Inventor: Steven Mark Bryant, Bethesda, MD (US)

(21) Appl. No.: 15/936,083

(22) Filed: Mar. 26, 2018

(51) Int. Cl. H04L 29/06; H04W 12/08; G01S 19/51; G01S 11/06

(52) U.S. Cl. CPC H04L 63/107; H04W 12/08; H04W 4/80; G01S 11/06; G01S 19/51

(57) ABSTRACT

For each area of a service subscriber, an occupancy control server maintains an access control list and a census of authorized occupants within the area. The server receives a query from a mobile security device, checks for access control permission, and transmits an updated census of authorized occupants to each authorized occupant in the area. Each occupant transmits its identification indicia and responds to requests. Each occupant demands an encrypted credential from a responding mobile security device not found in the most recently updated list and relays it to the occupancy control server for validation.

### BACKGROUND OF THE INVENTION

### Technical Field

The disclosure relates to physical occupancy control over areas.

Today it is very difficult to validate that the people present in the secured environment actually have credentials to allow them in that environment. Intruders can easily “tailgate” through the secured perimeter.

As is known, badges on lanyards are often backwards and people forget to display them properly, making casual checking awkward and socially difficult. Also, mobile credentials cannot be passively validated today. Typically, a bearer must actively request entry or access through a portal.

What is needed is a way for to check that the current occupants of an area are all credentialed unobtrusively.

### BRIEF SUMMARY OF INVENTION

A plurality of mobile security devices is intermittently communicatively coupled to a security server and to each other mobile security device in an area. The server maintains and distributes an authoritative census of authenticated authorized occupants (CAO) of each area and each mobile security device downloads a timestamped local version of the census. An advertising mobile security device signals its presence by transmitting Identification Indicia (I*I) such as but not limited to a wireless protocol identifier, MAC address, UUID, user id or phone id.

Upon receipt of advertiser's I*I (identification indicia e.g. user id or phone id), the mobile security device checks its most recent local version of the census. When an I*I is not found in the latest census, the verification packet behind the I*I is requested and relayed to the server. The server checks for authorization of the unfound I*I to be in the area and triggers an alert and/or transmits to each authorized occupant in the area, an updated census of authorized occupants, which immediately takes effect. A people counting apparatus provides a count of humans which is compared to the expected census of authorized occupants.

A system includes a first mobile security device; at least one second mobile security device(s); a secure occupancy control server; an optional people counting apparatus; an optional portal control apparatus; and a wireless communication network coupling all the above.

Other refinements include using GPS and radio signal strength for determining if detected devices should be considered to be in the area.

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIG. 1 is a transaction sequence between system components;

FIGS. 2-4 are flow charts of method embodiments;

FIG. 5 is a block diagram of data flow between system components;

FIG. 6 is a block diagram of a processor suitable for performing a method embodiment of the invention; and

FIGS. 7A, 7B, and 8 are flowcharts of method steps in a server and in a plurality of mobile security devices.

### DETAILED DESCRIPTION OF INVENTION

A sequence of transactions between the system components provides a peer-based occupancy control system.

In an embodiment, at a first mobile security device, upon successful entry into a secured area, transmitting a first self-identity and request for identification to at least one second mobile security device; at a second mobile security device, responding to a received request for identification by transmitting a second self-identity and updating a census of occupants with the first self-identity; at the first mobile security device, updating a census of occupants with at least one second self-identity, and transmitting a first secure area current census to a secure occupancy control server; at the secure occupancy control server, receiving at least one census of occupants, verifying occupancy by authorized identities, and one of transmitting an intruder alert upon determining an occupant without an authorized identity for that area, and transmitting annotated census to all verified occupants of the secured area upon verifying occupancy only by authorized identities.

In an embodiment, the process of the server also includes receiving an integer from a people counting apparatus e.g. skeletons from a video skeleton sensor apparatus, and alerting when the count is not equal to the number of census of occupants.

In an embodiment, the process of the server also includes updating the count of current census with ingress or egress events of the portal control apparatus; and alerting when the count of current census is inconsistent with net authorized occupants.

In another embodiment of the invention, a method for operation of an occupancy control server includes: at the secure occupancy control server, receiving from at least one mobile security device in an area, at least one census of occupant identities within said area, verifying occupancy by authorized identities; transmitting an intruder alert upon determining an occupant without an authorized identity for that area; and transmitting annotated census to all verified occupants of the secured area upon verifying occupancy only by authorized identities.

In an embodiment, a method includes receiving a count of skeletons from a video skeleton sensor apparatus, and alerting when the count exceeds the number of census of occupants.

In an embodiment, a method includes updating a first census with ingress or egress events of the portal control apparatus; and alerting when the first census is inconsistent with a second census reported by a mobile security device.

In another embodiment of the invention, a method for operation of a first mobile security device in an occupancy controlled area includes: upon expiration of a first periodic or pseudo-random period of time, transmitting a first self-identity electronic signature and request for a responsive second identity electronic signature from at least one second mobile security device; storing at least one responsive second identity electronic signature into a non-transient computer readable medium as an incremental census of occupancy; waiting during a second periodic or pseudo-random period of time, for reception of an authoritative census of authorized occupant identities from an occupancy control server; upon expiration of the second periodic or pseudo-random period of time without reception of the authoritative census, transmitting to the occupancy control server said incremental census for verification; and upon receipt of an authoritative census, replacing the incremental census with the authoritative census and restarting the plurality of periodic or pseudo-random period-of-time processes.

One aspect of the invention is a method of a processor at a 1^{st} mobile security device by performing computer-executable instructions stored in a non-transient machine readable medium: upon timer sleep expiration (timer) triggering, fully activating application and resetting timer for next dormant period; broadcasting identity request for at least one second mobile security device within range; randomly (or regular recurring poll), or upon entering a first secure Area A, broadcasting a request for other mobile security device id credentials; receiving responsive encrypted id credentials from at least one 2^{nd} mobile security device; validating encrypted id credential with security control server: updating a current census of occupants of Area A; checking current census with most recent census of authorized occupants; and when check fails, transmitting to security server, time, hash, id, area, location indicia; receiving one of updated census of authorized occupants of Area A and security alert; and receiving from server a notification of occupants without a credential in shared area. Within this application “id” refers to one of the person's unique id as kept by the authoritative server, the unique phone id, or a combination of the two.

Another aspect of the invention is a method at a 1^{st} mobile security device: upon timer sleep expiration (timer) triggering, fully activating application and resetting timer for next dormant period; broadcasting for other nearby mobile security devices randomly (or regular recurring poll), or upon entering a first secure Area A, broadcasting a request for other mobile security device id credentials; detecting a nearby BT smart device that does not report any id credential; transmitting wirelessly to a security server by cellular radio, that a BT smart phone was detected in Area A that did not participate in the security service; and receiving from a server a notification of occupants in shared area not validated by the security service.

Another aspect of the invention is a method of a security server performing by a processor: maintaining a census of authorized occupants of a first secure Area A; receiving from a first mobile security device a current census of occupants; checking current census with most recent census of authorized occupants; checking access control list of incremental current occupants for authorization; transmitting updated census to all authorized occupants of first secure Area A; and when a check of access control list fails, transmitting a security alert to designated individuals via email, text message, or other electronic means; and receiving location indicia from mobile security devices to update census of authorized occupants within each secure area.

Another aspect of the invention is a method at a security server comprising the processes: maintaining a census of authorized occupants of a first secure Area A; receiving from a smart video camera system census of occupants within Area A receiving from a first mobile security device a current census of occupants; checking current census with most recent census of authorized occupants; checking access control list of incremental current occupants for authorization; transmitting updated census to all authorized occupants of first secure Area A; and when a check of access control list fails, transmitting a security alert to security desk and to first mobile security device and other mobile security devices known to be in the secure area; comparing a total count of occupants from smart video system coupled to a people counting apparatus, with total count of occupants as reported by all mobile security devices within Area A, and generating security alert if the counts do not match.

Another aspect of the invention is a method performed at a security server by executing the computer-readable stored instructions: maintaining a census of authorized occupants of a first secure Area A; receiving from a first mobile security device a notification of BlueTooth (BT) smart phone in Area A that does not have any credential, and transmitting a security alert to security desk and/or to all mobile security devices in Area A and/or to authorized list of individuals to receive these warnings.

In an embodiment, the method also includes validating the encrypted credential submitted by the first mobile device, for each additional mobile security device found in its census.

Another aspect of the invention is a method at a 1^{st} mobile security device communicatively coupled by a wireless network to at least one second mobile security device: listening for annunciations from the at least one second mobile security device; randomly or upon entering a first secure Area A, annunciating id credentials; receiving responsive id credentials from at least one 2^{nd} mobile security device; updating a current census of occupants of Area A; checking current census with most recent census of authorized occupants; when check fails, transmitting to security server, time, hash, id, area; and receiving one of updated census of authorized occupants of Area A and security alert.

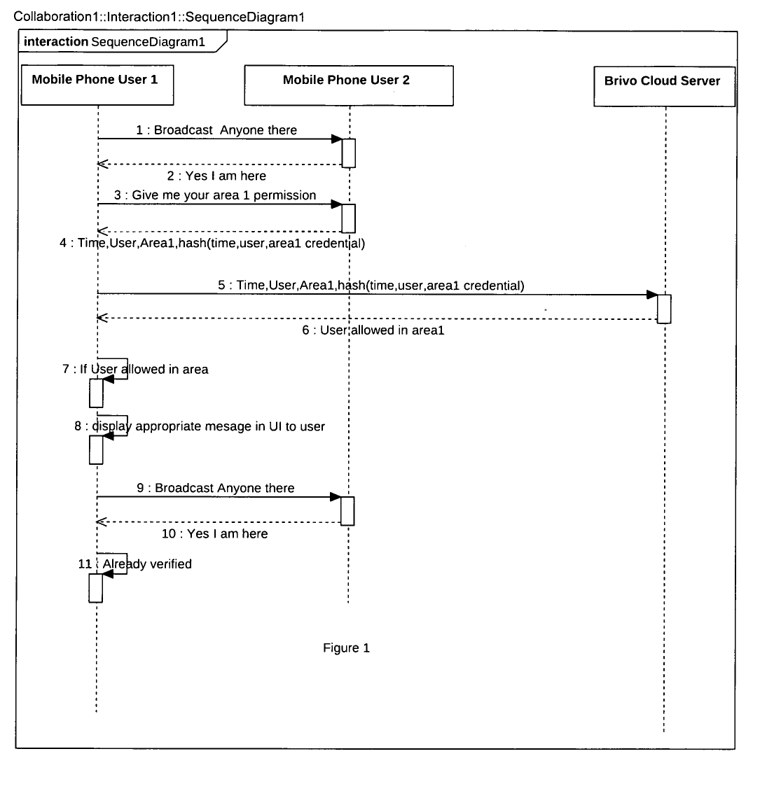

Referring now to the figures, FIG. 1 is an illustration of transactions of an occupancy control system. Transaction 1, a broadcast transmission from a first Mobile Phone User: Is anyone there?; Transaction 2: a reply from a second Mobile Phone User “Yes I am here” (new MPU discovered); Transactions 3&4: Direct communications between MPU1 and MPU2: request for Time, Area 1 hash, and reply; Transactions 5&6 Direct communication between MPU1 and server: Time, Area 1 hash of MPU2 relayed for verification, and “Allowed in Area 1” Step 7 Store updated allowance for MPU2, Step 8, Display message un UI, Steps 9-11, Broadcast transmission from MPU1 “Is anyone there?” Multiple replies: “Yes I am here” Checking previous allowance store: (all recognized); no action, sleep.

When MPU1 enters an area, its Allowance store will be empty and all received hashes are uploaded to the server for verification. When MPU1 has been in the area for a while, it will randomly, (or periodically), check to discover any new entrant, or confirm that its Allowance store matches the replies to its broadcast.

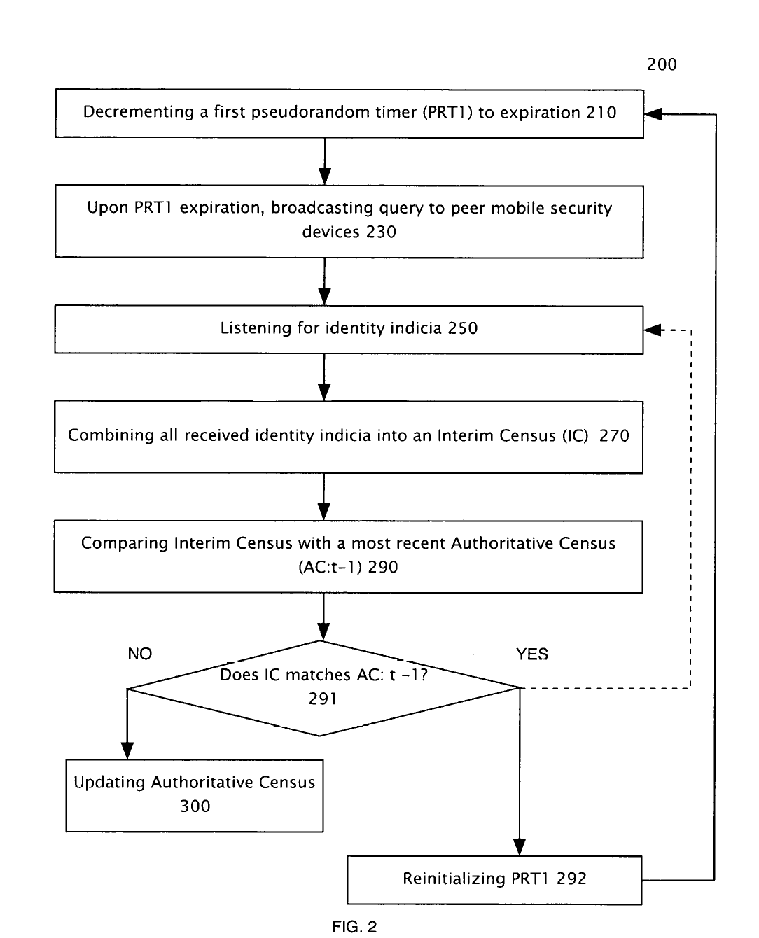

FIG. 2 is a process flowchart for a method 200 of operation for at least one first mobile security device in communication with an occupancy control server and at least one second mobile security device: the method includes listening for identity indicia transmitted by at least one mobile security device 250; combining all received identity indicia into an Interim Census (IC) 270; comparing said Interim Census with a most recent Authoritative Census (AC:t−1) 290; determining when IC matches AC:t−1 291; when true, continuing method 200; and when not true, updating the Authoritative Census by process 300. In one embodiment, the process also includes decrementing a first pseudorandom timer (PRT1) to expiration 210 and upon PRT1 expiration, broadcasting a query to peer mobile security devices 230.

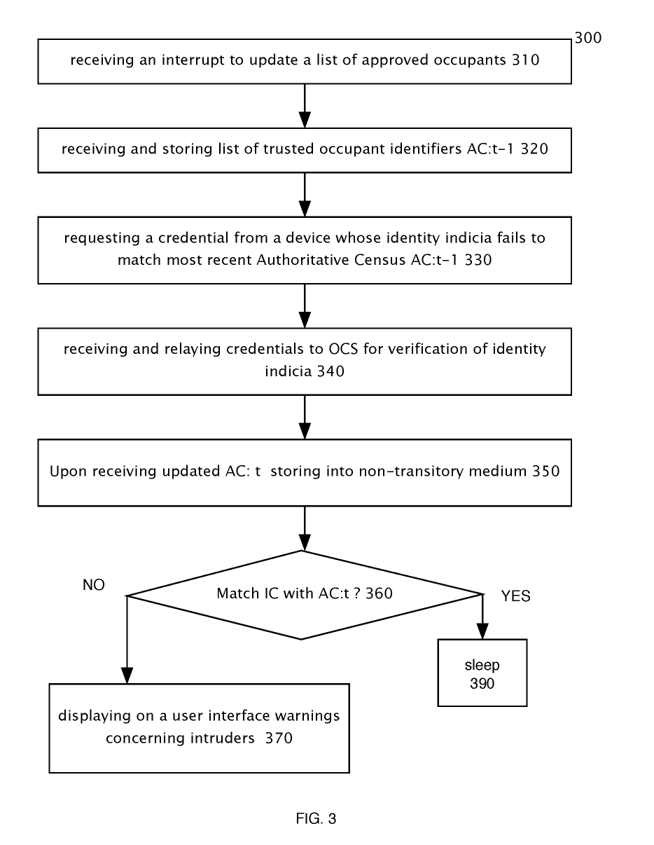

FIG. 3 provides a flowchart for process 300 updating the Authoritative Census of FIG. 2 including the steps: requesting a credential from a device whose identity indicia fails to match any member of the most recent Authoritative Census AC:t−1 330; receiving and relaying said credential an Occupancy Control Server (OCS) for verification of an identity indicia 340; upon receiving updated Authoritative Census AC:t, storing into non-transitory medium 350; determining when the interim census (IC) matches the updated Authoritative Census (AC:t) 360; when true, sleeping the process 390; and when not true, displaying on a user interface warnings concerning intruders 370.

In an embodiment, the process also includes receiving an interrupt to update a list of approved occupants 310; and receiving and storing the list of trusted occupant identifiers AC:t−1 320.

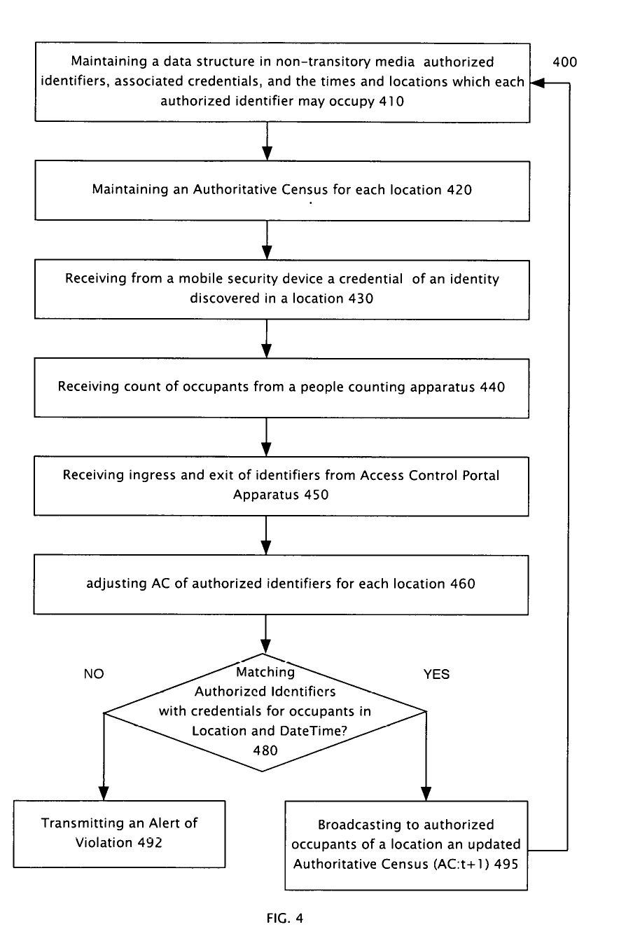

FIG. 4 is a process flowchart of a method 400 of operation of an occupancy control server: maintaining a data structure in non-transitory storage of authorized identifiers, associated credentials, and the times and locations which each authorized identifier may occupy 410; maintaining an Authoritative Census for each location 420; receiving from a mobile security device of an identity discovered in a location 430; adjusting the Authoritative Census of authorized identifiers for each location 460; determining a condition that Authorized Identifiers match with credentials for occupants in location and DateTime 480; when true, broadcasting to authorized occupants of a location an updated authoritative census (AC:t+1) 495; and when false, transmitting an Alert 492.

In an embodiment, the method 400 further includes receiving a count of occupants from a people counting apparatus 440; and receiving ingress and exit of identifiers from Access Control Portal Apparatus 450.

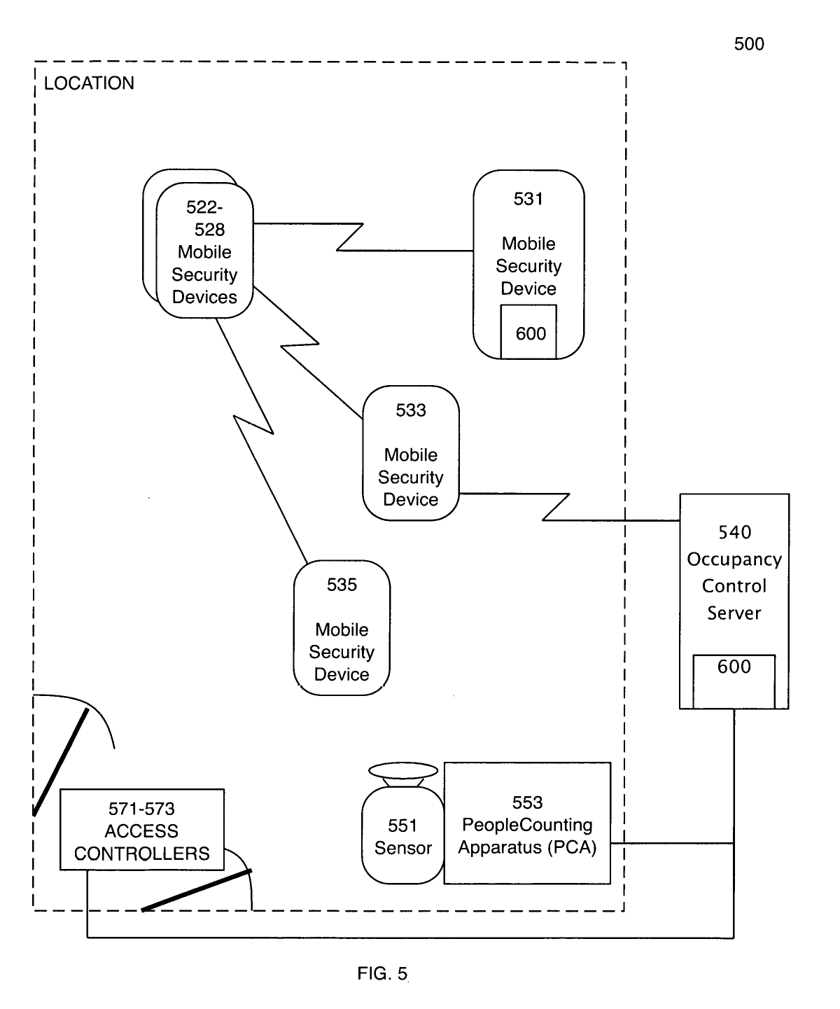

FIG. 5 is a block diagram of elements of a peer based mobile security system. At least one of a plurality of peer Mobile Security Devices 522-528, 531-535 is communicatively coupled to an Occupancy Control Server 540. In an embodiment the system further includes a Sensor 551, e.g. an image capture device (camera) coupled to a People Counting Apparatus (PCA) 553 which provides by a communication channel to the Occupancy Control Server, a count of occupants within a Location also populated by the plurality of Mobile Security Devices. In an embodiment, the system further includes a plurality of Access Controllers 571-573 which actuate portals which identify entrance or egress events of said Mobile Security Devices. The system includes computing devices 600 performing instructions encoded on non-transitory media embedded within each Device and Server to request, respond, and transmit credentials and distribute an authoritative census of authorized occupants (ACAO) or a localized subset (LCAO) thereof.

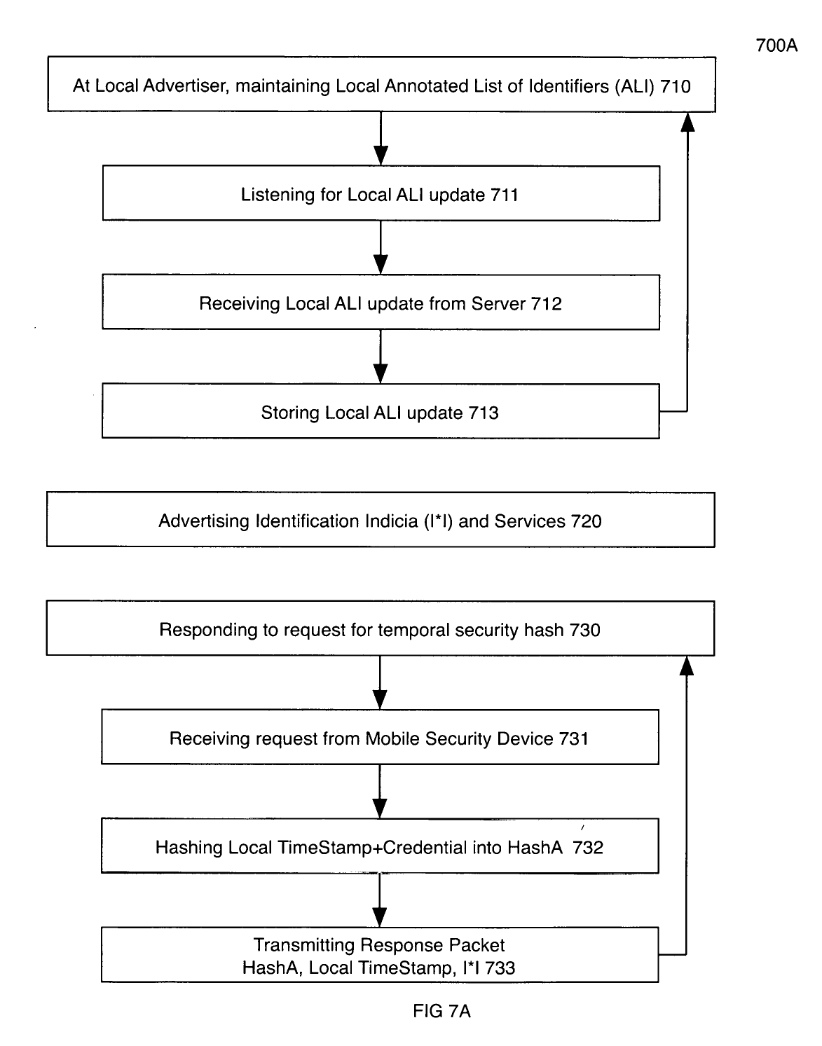

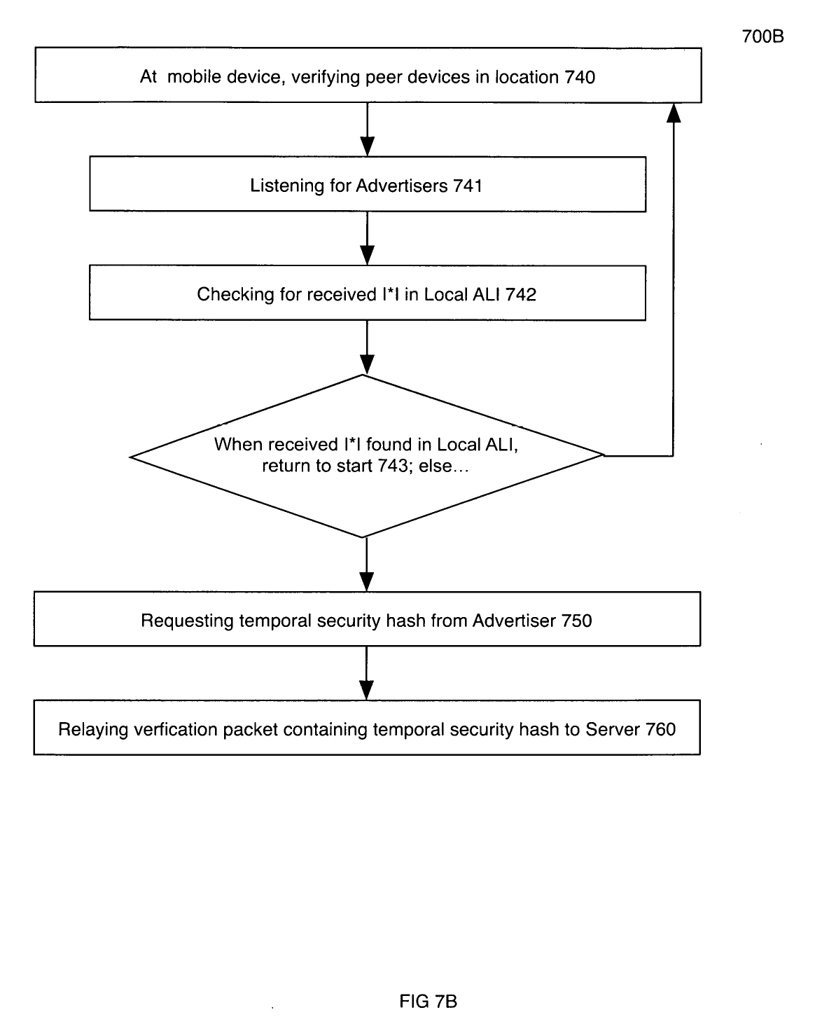

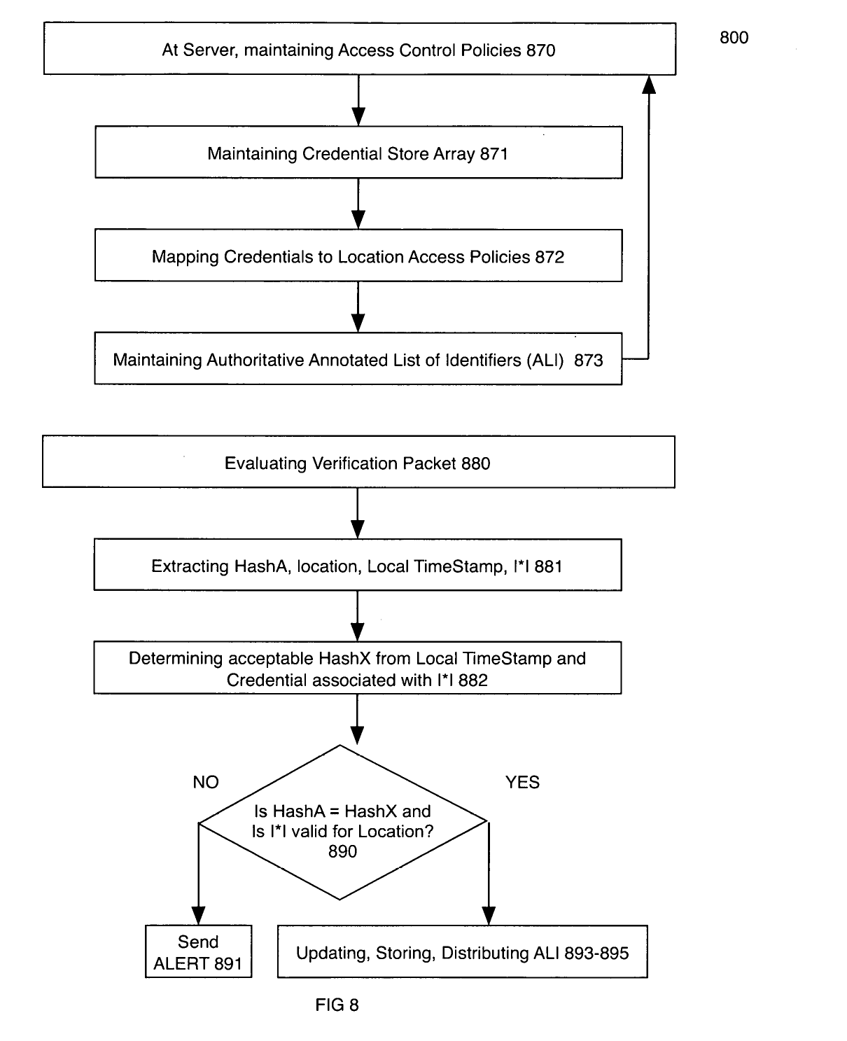

FIGS. 7A, 7B, and 8 are flowcharts of method steps in a server and in a plurality of mobile security devices. Methods 700A and 700B are performed by a processor in a mobile security device by executing instructions encoded in non-transitory storage to cause the radio and logic circuits to perform the processes: at a local advertiser, maintaining local Annotated List of Identifiers (ALI) 710; advertising identification indicia (I*I) and services 720; and responding to request for temporal security hash 730. In an embodiment maintaining the local annotated list of identifiers comprises listening for local ALI update 711, receiving local ALI update from server 712, and storing local ALI update 713. In an embodiment responding to request for temporal security hash 730 comprises receiving request from mobile security device 731, hashing local time stamp and credential into HashA 732, and transmitting a response packet comprising HashA, local timestamp, I star I 733.

In an embodiment, the method further includes method 700B illustrated in FIG. 7B: at a mobile device, verifying peer devices in its location 740; requesting a temporal security hash from a mystery Advertiser 750; and relaying to a Server 760, a verification packet containing the temporal security hash when provided by the mysterious Advertiser, wherein a mystery Advertiser is one not found in a Local Annotated List of Identifiers. In an embodiment, verifying peer devices in a location comprises: listening for Advertisers 741, checking said Advertiser's Identification Indicia (I*I) for presence in a Local ALI of the mobile device 742, and returning to start 743 when found, or when not found, requesting and relaying a verification packet containing the temporal security hash 750-760.

Method 800 comprises processes performed by a processor in a server by executing instructions encoded in non-transitory storage to cause radio and logic circuits to: at a server, Maintaining access control policies 870 and Evaluating verification packets 880. In an embodiment, maintaining access control policies include maintaining credential store array 871, mapping credentials to location access policies 872 and maintaining authoritative Annotated List of Identifiers (ALI) 873. In an embodiment, evaluating verification packet 880 comprises extracting HashA, location, local time stamp, I star I 881 and determining acceptable HashX from local time stamp and credential associated with I star I 882 and determining Is HashA equal to HashX and is I star I valid for location 890. If both are true then the process proceeds to updating storing and distributing the new ALI steps 893 through 895 else send an alert 891.

As is known, circuits disclosed above may be embodied by programmable logic, field programmable gate arrays, mask programmable gate arrays, standard cells, and computing devices limited by methods stored as instructions in non-transitory media.

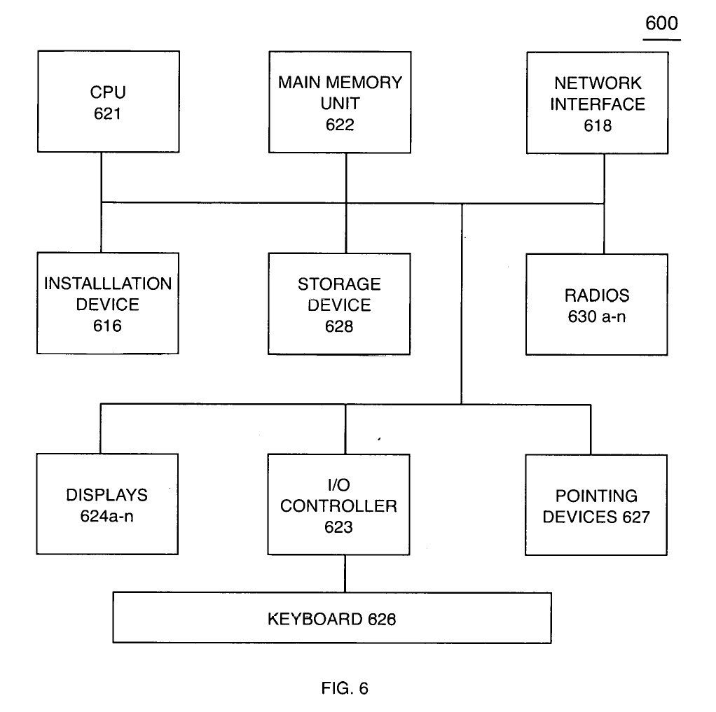

Generally a computing device 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device. FIG. 6 depicts block diagram of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Zigbee, Z-wave, cellular, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 618 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments, the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; or Alphabet of Mountain View Calif. In yet other embodiments, the computing device 600 is a smart phone, camera, augmented reality headset, or other portable mobile device.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

It should be understood that the systems described above may provide multiple ones of any or each of those components and these components may be provided on either a standalone machine or, in some embodiments, on multiple machines in a distributed system. The phrases in one embodiment', in another embodiment', and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output is provided to at least one output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, PYTHON or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

### CONCLUSION

The present invention is easily distinguished from conventional systems by using each mobile security device as a sentinel checking peer near-by mobile security devices for valid occupancy. It combines a video-based inventory with encrypted credentials provided by each bearer of a mobile pass device. It can easily be distinguished from conventional system that depend on entrance or egress event through an instrumented portal.

Aspects of the invention include a method at a mobile security device comprising a process for searching for and a process for updating mobile security devices approved by an Authority for occupancy of an area wherein a mobile security device comprises a circuit to generate a temporal security hash upon demand. In an embodiment, the process for searching for new devices in proximity comprises: upon 1^{st} timer expiration, initiating peer occupancy application steps at a 1^{st} mobile security device; transmitting query to RF neighborhood requesting response packet from mobile devices; upon receiving at least one response packet, determining for device a characterization of being a 2^{nd} mobile security device, and not being a 2^{nd} mobile security device, and storing determination as a list of current mobile security devices in proximity to 1^{st} mobile security device; comparing said list of current 2^{nd} mobile security devices in proximity, with previously stored list of most recent approved list from Authority for exceptions; when exception count is zero, reinitializing 1^{st} timer; when exception count is non-zero, obtaining validation for each exception. In an embodiment, obtaining validation for each exception comprises: requesting a temporal security hash from the exception; relaying received said temporary security hash to authority in a request for validation of exception; receiving validation response from security authority; and displaying to a user interface of 1^{st} mobile security device, a message transformation of security authority response to request for validation of exception. In an embodiment, the process for getting most recent list of approved occupants from authority comprises: at a 1^{st} mobile security device, initiating an updating process responsive to receiving a first interrupt from an Authority, the updating process comprising; receiving a list of acceptable identification indicia (I*I) for each device currently approved to occupy an area. receiving any notifications of unacceptable I*I for each device in said area; and displaying on a user interface warnings concerning unacceptable I*I devices in the area. Another aspect of the invention is a method at a 1^{st} mobile security device: upon timer sleep expiration (timer) triggering, fully activating application and resetting timer for next dormant period; broadcasting identification indicia (I*I); transmitting a request for other mobile security device temporal security hash when unable to find identification indicia in an annotated list; receiving responsive timestamp, temporal security hash, and I*I from at least one 2^{nd} mobile security device; transmitting to security server, said timestamp, temporal security hash, I*I, and location indicia; receiving one of updated census of authorized occupants of Area A and security alert; and receiving from server a notification of unauthorized occupants in shared area. In an embodiment, the method further includes: upon timer sleep expiration (timer) triggering, fully activating application and resetting timer for next dormant period; broadcasting for other nearby mobile security devices a request for other mobile security device id credentials; detecting a nearby BT smart phone that does not report any id credential; transmitting to a security server, that a BT smart phone was detected in Area A that did not respond with recognizable id credential; and receiving from a server a notification of a BT smart phone allowed in shared area. Another aspect of the invention is a method at a security server: maintaining a census of authorized occupants of a first secure Area A; receiving from a first mobile security device a verification packet related to an identification indicia (I*I); checking verification packet against most recent census of authorized occupants; checking access control list of incremental current occupants for authorization in first secure Area A; transmitting updated census to all authorized occupants of first secure Area A; and when a check of access control list fails, transmitting a security alert to designated individuals via email, text message, or other electronic means; and receiving location indicia from mobile security devices to update census of authorized occupants within each secure area. In an embodiment, the method further includes: maintaining a census of authorized occupants of a first secure Area A; receiving from a people counting apparatus an integer value of persons within Area A receiving from a first mobile security device at least one verification packet; checking an access control list for a credential consistent with the verification packet; transmitting updated census to all authorized occupants of first secure Area A; and when a check of access control list fails, transmitting a security alert to security desk and to first mobile security device; comparing a person count of a people counting apparatus, with identity count of identification indicia as reported by all mobile security devices within Area A, and generating security alert if the counts do not match. Another aspect of the invention is a method for operation of a credential verification server by performing executable instructions stored in non-transitory media in at least one processor, comprising the asynchronous processes: maintaining a list on computer-readable storage of identification indicia of mobile devices verified to be safely within proximity to at least one location; maintaining a reference table on computer-readable storage of identification indicia associated with at least one mobile security system credential; receiving from at least one mobile security device at least one verification packet comprising a first advertiser timestamp, a first advertiser identification indicia, and a first hash of a mobile security system credential of first advertiser and said first advertiser timestamp; hashing said first advertiser timestamp with at least one element of the table of mobile security system credentials to produce a second hash; upon successful matching of a first hash and a second hash, updating said annotated list and distributing said updated annotated list. In an embodiment, the method further includes:sending a user_id and including said user_id in hashing. Another aspect of the invention is a method of operation of a first mobile security device in an on premises credential verification system by performing executable instructions stored in non-transitory media in at least one processor comprising the processes: listening for a transmission from an on premises credential verification server and updating an annotated list of identification indicia upon reception; advertising according to a wireless protocol, its identification indicia; responding to a request by hashing its first advertiser timestamp with its mobile security system credential to produce a first hash, and transmitting its first advertiser identification indicia, its first advertiser timestamp, and said first hash. In an embodiment, the method further includes: receiving at least one transmission from a first advertiser; searching the annotated list of identification indicia with the identification indicia in the transmission of first advertiser; upon failure to find the identification indicia of first advertiser in said annotated list, transmitting a request to said first advertiser; and relaying a response to said request to the server. In an embodiment, the method further includes: using GPS data from smart phones to additionally determine if detected device is inside or outside the protected area. In an embodiment, the method further includes: using BT radio power level as an additional mechanism to determine if the device is inside or outside of the protected area. In an embodiment, the method further includes: using very low power level, an individual can self check a single other person close to them for a valid credential.

Having described certain embodiments of methods and systems for restricting physical access, it will now become apparent to one of skill in the art that other embodiments incorporating the concepts of the disclosure may be used. Therefore, the disclosure should not be limited to certain embodiments, but rather should be limited only by the spirit and scope of the following claims.

I claim:

1. A method at a mobile security device comprising a process for searching for new devices in proximity, and a process for updating mobile security devices approved by an Authority for occupancy of an area wherein a mobile security device comprises a circuit to generate a temporal security hash upon demand.

2. The method of claim 1 wherein, the process for searching for new devices in proximity comprises:
upon 1^{st} timer expiration, initiating peer occupancy application steps at a 1^{st} mobile security device;
transmitting query to RF neighborhood requesting response packet from mobile devices;
upon receiving at least one response packet, determining for device a characterization of being a 2^{nd} mobile security device, and not being a 2^{nd} mobile security device, and
storing determination as a list of current mobile security devices in proximity to 1^{st} mobile security device;
comparing said list of current 2^{nd} mobile security devices in proximity, with previously stored list of most recent approved list from Authority for exceptions;
when exception count is zero, reinitializing 1^{st} timer;
when exception count is non-zero, obtaining validation for each exception.

3. The method of claim 2 wherein obtaining validation for each exception comprises:
requesting a temporal security hash from the exception;
relaying received said temporary security hash to authority in a request for validation of exception;
receiving validation response from security authority; and
displaying to a user interface of 1^{st} mobile security device, a message transformation of security authority response to request for validation of exception.

4. The method of claim 3 wherein the process for updating mobile security devices approved by an Authority for occupancy of an area comprises:
at a 1^{st} mobile security device, initiating an updating process responsive to receiving a first interrupt from an Authority, the updating process comprising;
receiving a list of acceptable identification indicia (I*I) for each device currently approved to occupy an area;
receiving any notifications of unacceptable I*I for each device in said area; and
displaying on a user interface warnings concerning unacceptable I*I devices in the area.

5. A method at a security server comprising:
maintaining a census of authorized occupants of a first secure Area A;
receiving from a first mobile security device a verification packet related to an identification indicia (I*I);
checking verification packet against most recent census of authorized occupants;
checking access control list of incremental current occupants for authorization in first secure Area A;
transmitting updated census to all authorized occupants of first secure Area A; and
when a check of access control list fails, transmitting a security alert to designated individuals; and
receiving location indicia from mobile security devices to update census of authorized occupants within each secure area.

6. The method of claim 5 further comprising:
maintaining a census of authorized occupants of a first secure Area A;
receiving from a people counting apparatus an integer value of persons within Area A
receiving from a first mobile security device at least one verification packet;
checking an access control list for a credential consistent with the verification packet;
transmitting updated census to all authorized occupants of first secure Area A; and
when a check of access control list fails, transmitting a security alert to security desk and to first mobile security device;
comparing a person count of a people counting apparatus, with identity count of identification indicia as reported by all mobile security devices within Area A, and
generating security alert if the counts do not match.

7. A method of operation of a first mobile security device in an on premises credential verification system by performing executable instructions stored in non-transitory media in at least one processor comprising the processes:
listening for a transmission from a credential verification server and updating an annotated list of identification indicia upon reception;
advertising according to a wireless protocol, its identification indicia;
responding to a request by hashing its first advertiser timestamp with its mobile security system credential to produce a first hash, and transmitting its first advertiser identification indicia, its first advertiser timestamp, and said first hash.

8. The method of operation of claim 7 further comprising:
receiving at least one transmission from a first advertiser;
searching the annotated list of identification indicia with the identification indicia in the transmission of first advertiser;
upon failure to find the identification indicia of first advertiser in said annotated list, transmitting a request to said first advertiser; and
relaying a response to said request to the server.

9. The method of claim 7 further comprising:
using GPS data from smart phones to additionally determine if detected device is inside or outside the protected area.

10. The method of claim 7 further comprising:
using BT radio power level as an additional mechanism to determine if the device is inside or outside of the protected area.

11. The method of claim 7 further comprising:
using very low power level, an individual can self check a single other person close to them for a valid credential.
